(19) United States
(12) Patent Application Publication
(10) Pub. No.: US 2013/0175885 A1
(43) Pub. Date: Jul. 11, 2013

(54) VOICE COIL MOTOR CAPABLE OF INCREASING FOCUSING ACCURACY

(71) Applicant: Hsiang-Chieh Yu, New Taipei (TW)

(72) Inventor: Hsiang-Chieh Yu, New Taipei (TW)

(73) Assignee: HON HAI PRECISION INDUSTRY CO., LTD., New Taipei (TW)

(21) Appl. No.: 13/535,749

(22) Filed: Jun. 28, 2012

(30) Foreign Application Priority Data
Jan. 10, 2012 (TW) 101100977

(51) Int. Cl. H02K 41/035

(52) U.S. Cl. 310/12.16

(57) ABSTRACT

A voice coil motor (VCM) includes a moving unit and a fixing unit, and the moving unit is movably received in the fixing unit. The moving unit includes a moving barrel, a first coil assembly, and a second coil assembly. The moving barrel includes a first outer surface. The first coil assembly is sleeved on the first outer surface. The second coil assembly includes four coils positioned at corners of the first outer surface. The fixing unit includes a fixing frame, a first magnet assembly, and a second magnet assembly. The first coil assembly is opposite to the first magnet assembly, and the second coil assembly is opposite to the second magnet assembly.

### BACKGROUND

1. Technical Field

The present disclosure relates to voice coil motors (VCMs) and, particularly, to a VCM capable of increasing focusing accuracy of a camera module in which the VCM is applied.

2. Description of Related Art

VCMs generally include a moving unit, a fixing unit, and a spring element connected between the moving unit and the fixing unit. The moving unit is received in the fixing unit and is driven to move relative to the fixing unit under a magnetic force. However, because of assembly error or design error, a spring force of the spring element is not uniformly applied on the moving unit, which may result in decreased focusing accuracy.

Therefore, it is desirable to provide a VCM, which can overcome the limitations described.

### BRIEF DESCRIPTION OF THE DRAWINGS

FIG. 1 is an assembled view of a VCM in accordance with an exemplary embodiment.

FIG. 2 is an isometric, exploded, and schematic view of the VCM of FIG. 1.

FIG. 3 is similar to FIG. 2, but viewed from another angle.

### DETAILED DESCRIPTION

Embodiments of the disclosure will be described with reference to the drawings.

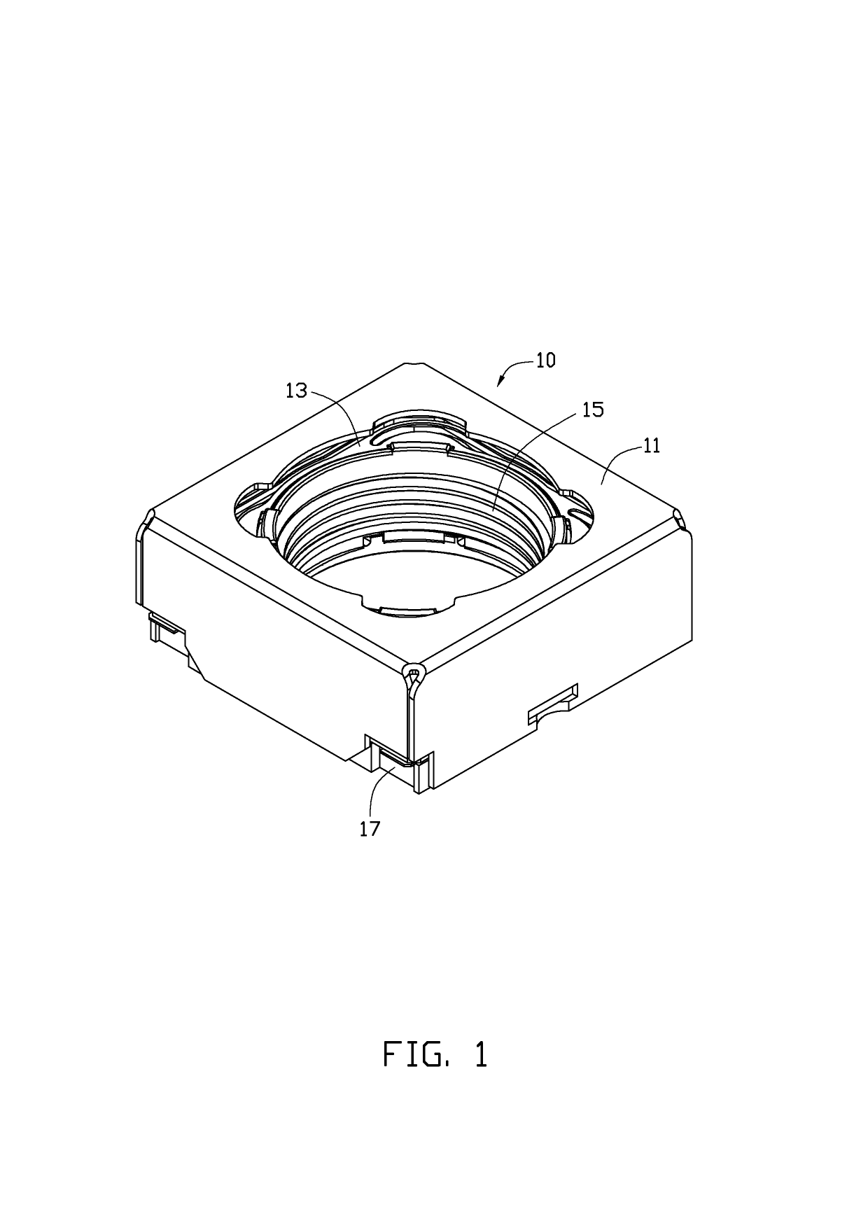

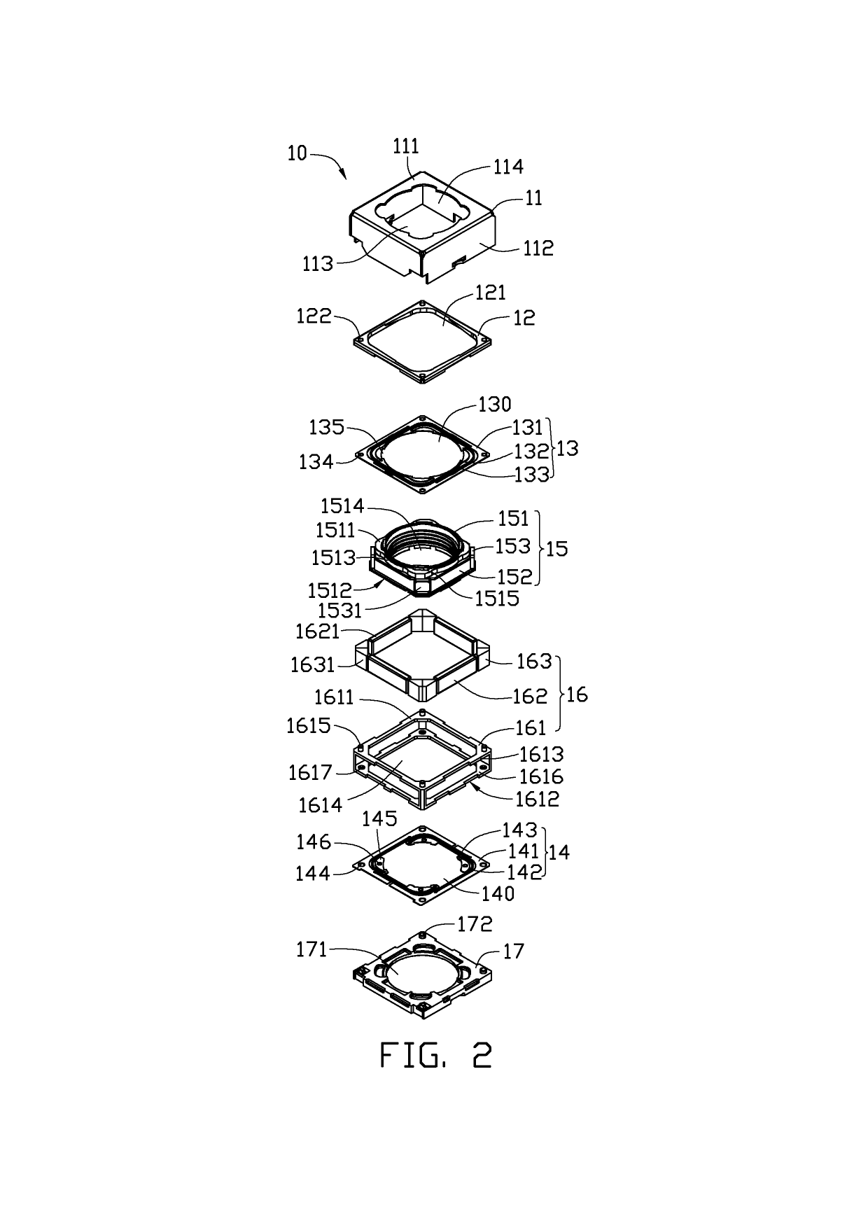

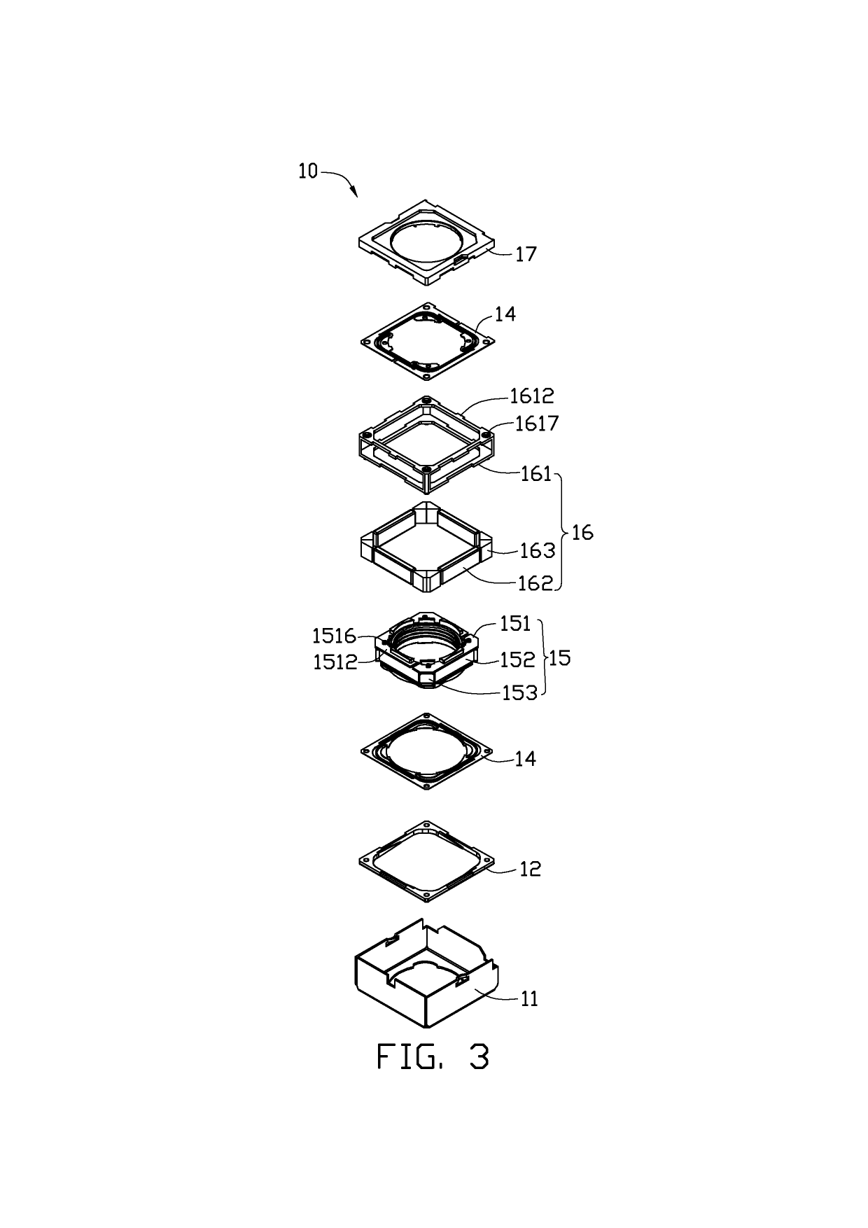

Referring to FIGS. 1-3, a VCM 10, according to an exemplary embodiment includes a case 11, an upper plate 12, an upper spring 13, a lower spring 14, a moving unit 15, a fixing unit 16, and a lower plate 17.

The case 11 has a cubic configuration and includes an upper cover plate 111 and a sidewall 112 substantially perpendicularly extending downward from peripheral edges of the cover plate 111. The cover plate 111 and the sidewall 112 cooperatively define a receiving room 113. The cover plate 111 centrally defines a first through hole 114 communicating with the receiving room 113. In this embodiment, the cover plate 111 is generally rectangular, and the sidewall 112 includes four plates extending downwards from four edges of the cover plate 111 that are connected to each other.

The upper plate 12 is square shaped and defines a second through hole 121 generally at a central portion thereof. The upper plate 12 defines four first positioning holes 122 at four corners thereof.

The upper spring 13 is planar and centrally defines a third through hole 130. The upper spring 13 includes a first outer portion 131, a first inner portion 132, and a first elastic portion 133 connected between the first outer portion 131 and the first inner portion 132. The first outer portion 131 defines four first connection holes 134 at four corners thereof. The first inner portion 132 equidistantly defines four first notches 135 communicated with the third through hole 130.

The lower spring 14 is planar and centrally defines a fourth through hole 140. The lower spring 14 includes a second outer portion 141, a second inner portion 142, and a second elastic portion 143 connected between the second outer portion 141 and the second inner portion 142. The second outer portion 141 defines four second connection holes 144 at corners thereof. The second inner portion 142 includes four blades 145 adjacent to corners of the second outer portion 141. Each blade 145 defines a third connection hole 146.

The moving unit 15 includes a moving barrel 151, a first coil assembly 152, and a second coil assembly 153. The moving barrel 151 includes an upper surface 1511, a lower surface 1512, and a first outer surface 1513 connected between the upper surface 1511 and the lower surface 1512. The moving barrel 151 defines a fifth through hole 1514 extending through the upper surface 1511 and the lower surface 1512. Four connection blocks 1515 equidistantly extend upward from the upper surface 1511, surrounding the fifth through hole 1514. Four first connection poles 1516 extend down from the lower surface 1512, generally at four corners of the lower surface 1512.

The first coil assembly 152 is annular shaped and is sleeved on the first outer surface 1513 of the moving barrel 151. The second coil assembly 153 includes four annular second coils 1531 attached on the first coil assembly 152 and positioned at corners of the outer surface 1513.

The fixing unit 16 includes a fixing frame 161, a first magnet assembly 162, and a second magnet assembly 163. The fixing frame 161 has a cubic configuration and includes a top surface 1611, a bottom surface 1612, and a second outer surface 1613 connected between the top surface 1611 and the bottom surface 1612. The fixing frame 161 defines a sixth through hole 1614 extending through the top surface 1611 and the bottom surface 1612. Four second connection poles 1615 extend up from the top surface 1611, generally at four corners of the top surface 1611. The fixing frame 161 defines four receiving holes 1616 on the second outer surface 1613. Each of the receiving holes 1616 is generally rectangular and communicates with the sixth through hole 1614. The fixing frame 161 defines four second positioning holes 1617 in the bottom surface 1612 generally at four corners of the bottom surface 1612.

The first magnet assembly 162 includes four generally rectangular first magnets 1621 respectively received in the receiving holes 1616 of the fixing frame 161. Each first magnet 1621 includes a magnetic pole directly facing the sixth through hole 1614, and the other magnetic pole of course facing away from the sixth through hole 1614. The second magnet assembly 163 includes four triangular second magnets 1631 respectively received in the corners of the fixing frame 161. Each second magnet 1631 is positioned between two adjacent first magnets 1621. One magnetic pole of each second magnet 1631 faces the top surface 1611, and the other magnetic pole faces the bottom surface 1612.

The lower plate 17 is square shaped and centrally defines a seventh through hole 171. Four third connection poles 172 extend up from corners of the lower plate 17 respectively.

During assembly of the VCM 10, the first magnet assembly 162 and the second magnet assembly 163 are received in the receiving holes 1616. Each second magnet 1631 is positioned at the corner of each two adjacent first magnets 1621. The moving unit 15 is movably received in the sixth through hole 1614. The first coil assembly 152 is opposite to the first magnet assembly 162, and the second coil assembly 153 is opposite to the second magnet assembly 163. The upper spring 13 is sandwiched between the upper plate 12 and the fixing frame 161. The second connection poles 1615 of the fixing frame 161 are received in the first connection holes 134 of the first outer portion 131 and the first positioning holes 122 of the upper plate 12. The connection blocks 1515 of the moving unit 15 are received in the first notches 135 of the first inner portion 132. The lower spring 14 is sandwiched between the lower plate 17 and the fixing frame 161. The third connection poles 172 of the lower plate 17 are received in the second connection holes 144 of the second outer portion 141 and the second positioning holes 1617 of the fixing frame 161. The first connection poles 1516 of the moving unit 15 are received in the third connection holes 146 of the second inner portion 142. The case 11 receives the upper plate 12, the upper spring 13, the lower spring 14, the moving unit 15, the fixing unit 16, and the lower plate 17. In an initial state, the first through hole 114, the second through hole 121, the third through hole 130, the fourth through hole 140, the fifth through hole 1514, the sixth through hole 1614, and the seventh through hole 171 are optically coaxial.

During the process of focusing, as the first coil assembly 152 is surrounded by the four first magnets 1621, when the first coil assembly 152 is supplied with a forward current or a reverse current, the first coil assembly 152 is given a Lorentz force along the optical axis of VCM 10. Therefore, the moving unit 15 is driven to move along the optical axis to find a focus position.

If the moving unit 15 inclines on a plane perpendicular to the optical axis, the two opposite second coils 1531 are supplied with a forward current or a reverse current, and the second coil assembly 153 given a Lorentz force perpendicular to the optical axis. Therefore, the moving unit 15 is driven to align with the fixing unit 16.

Particular embodiments are shown and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. A voice coil motor (VCM), comprising:
a moving unit comprising:
a moving barrel comprising a first outer surface;
a first coil assembly sleeved on the first outer surface; and
a second coil assembly comprising four coils, the four coils attached on the first coil assembly and positioned around the outer surface;
a fixing unit comprising:
a fixing frame comprising a top surface, a bottom surface, and a second outer surface connected between the top surface and the bottom surface; the fixing frame defining a through hole extending through the top surface and the bottom surface; the moving unit movably received in the through hole of the fixing frame; the fixing frame defining four receiving holes on the second outer surface;
a first magnet assembly comprising four first magnets; the first magnets respectively received in the receiving holes of the fixing frame and facing the first coil assembly; and
a second magnet assembly comprising four second magnets; each second magnet positioned between two adjacent first magnets and facing a respective one of the coils.

2. The VCM of claim 1, further comprising an upper spring connected to the moving barrel and the fixing frame.

3. The VCM of claim 2, wherein the upper spring comprises a first outer portion, a first inner portion, and a first elastic portion connected between the first outer portion and the first inner portion; the first outer portion is connected to the fixing frame; the first inner portion is connected to the moving barrel.

4. The VCM of claim 3, further comprising an upper plate, wherein the first outer portion is sandwiched the upper plate and the fixing frame.

5. The VCM of claim 1, further comprising a lower spring connected to the moving barrel and the fixing frame.

6. The VCM of claim 5, wherein the lower spring comprises a second outer portion, a second inner portion, and a second elastic portion connected between the second outer portion and the second inner portion; the second outer portion is connected to the fixing frame; the second inner portion is connected to the moving barrel.

7. The VCM of claim 6, further comprising a lower plate, wherein the second outer portion is sandwiched between the lower plate and the fixing frame.

8. The VCM of claim 1, further comprising a case, wherein the moving unit and the fixing unit are received in the case.
